(19) United States
(12) Patent Application Publication
(10) Pub. No.: US 2026/0091858 A1
(43) Pub. Date: Apr. 2, 2026

(54) Boat Launch Trailer Control System and Method

(71) Applicant: Continental Automotive Systems, Inc., Auburn Hills, MI (US)

(72) Inventors: Azam Kowalczyk, Sterling Heights, MI (US); Viljo Matti Petteri Wagner, Waterford Township, MI (US); Jean-Christophe Deniau, Fenton, MI (US)

(73) Assignee: Continental Automotive Systems, Inc., Auburn Hills, MI (US)

(21) Appl. No.: 19/344,894

(22) Filed: Sep. 30, 2025

Related U.S. Application Data
(60) Provisional application No. 63/701,552, filed on Sep. 30, 2024.

(51) Int. Cl. B63C 3/12; B60P 3/10; B60R 1/26; G01C 13/00

(52) U.S. Cl. CPC B63C 3/12; B60P 3/1033; B60R 1/26; G01C 13/008

(57) ABSTRACT

During a boat launch operation: receiving image data from at least one camera supported by the vehicle as the tow vehicle and trailer move in a reverse direction towards a body of water; determining a hull-pitch angle, an overlap ratio between a lower half of a hull of the boat and the water, and a submersion depth ratio measured from a hull keel of the boat; and transmitting an instruction to a user interface of the vehicle or a drive system thereof to cease movement of the tow vehicle and trailer in the reverse direction based upon the hull-pitch angle, the overlap ratio, and the submersion depth ratio all exceeding respective predetermined thresholds for at least a predetermined number of consecutive image frames.

### TECHNICAL FIELD

This disclosure relates to a tow vehicle configured to attach to a trailer. The tow vehicle assists in successfully launching a boat from the trailer in a body of water.

### BACKGROUND

Trailers are usually unpowered vehicles that are pulled by a powered tow vehicle. A trailer may be a utility trailer, a popup camper, a travel trailer, livestock trailer, flatbed trailer, enclosed car hauler, and boat trailer, among others. The tow vehicle may be a car, a crossover, a truck, a van, a sports-utility-vehicle (SUV), a recreational vehicle (RV), or any other vehicle configured to attach to the trailer and pull the trailer. The trailer may be attached to a powered vehicle using a trailer hitch. A receiver hitch mounts on the tow vehicle and connects to the trailer hitch to form a connection. The trailer hitch may be a ball and socket, a fifth wheel and gooseneck, or a trailer jack. Other attachment mechanisms may also be used. Backing up the trailer can be difficult for many people, especially those with little experience, and typically requires a second person (spotter) to guide and mitigate this challenge.

When towing a boat, a driver may put the boat supported by the trailer in the water to release the boat or the driver may take out the boat from the water. Usually, releasing or attaching the boat is done on an incline. It is often difficult to determine when reversing the trailer should cease, even with a spotter positioned rearwardly of the tow vehicle, for example. Releasing a boat in water that is too shallow may result in the boat being grounded, and releasing the boat in water that is too deep may result in the tow vehicle being stuck and unable to move forwardly or being otherwise subjected to water damage. It is desirable to have a tow vehicle having a system and method that safely overcome the challenges associated with launching a boat from a towed trailer with little or otherwise limited manual involvement.

### BRIEF SUMMARY

In accordance with one or more embodiments, during a boat launch operation: receiving image data from at least one camera supported by the vehicle as the tow vehicle and trailer move in a reverse direction towards a body of water; determining a hull-pitch angle, an overlap ratio between a lower half of a hull of the boat and the water, and a submersion depth ratio measured from a hull keel of the boat; and transmitting an instruction to a user interface of the vehicle or a drive system thereof to cease movement of the tow vehicle and trailer in the reverse direction based upon the hull-pitch angle, the overlap ratio, and the submersion depth ratio all exceeding respective predetermined thresholds for at least a predetermined number of consecutive image frames.

### BRIEF DESCRIPTION OF THE DRAWINGS

FIG. 1A is a top view of an example tow vehicle hitched to a trailer.

FIG. 1B is a top view of the example tow vehicle and the trailer shown in FIG. 1A, where the trailer is at an angle with respect to the tow vehicle.

FIGS. 1C and 1D are side views of the example tow vehicle and the trailer shown in FIG. 1A illustrating a boat launch scenario in which the vehicle and trailer are maneuvering in reverse along a downwardly-sloped surface.

FIG. 2 is a schematic block view of an example tow vehicle having a boat launch assist system.

FIG. 3 is a flowchart of an example arrangement of operations for use in maneuvering a tow vehicle during a boat launch.

FIGS. 4A-4C illustrate displayed camera views during a boat launch operation according to an example embodiment.

FIGS. 5A-5C illustrate displayed camera views during a boat launch operation according to another example embodiment.

FIG. 6 is a schematic block view of an example tow vehicle having a boat trailer hitch control system.

FIG. 7 depicts best fit lines, the angles of which, relative to the image horizon, are used for calculating the hull-pitch-angle signal.

FIG. 8 depicts a percentage of the hull's lower half that overlaps with the water.

FIG. 9 depicts first water in lower half approximately 30% of the way from the bottom of the keel (y_bot) to the top of the hull (y_top).

Like reference symbols in the various drawings indicate like elements.

### DETAILED DESCRIPTION

A tow vehicle, such as, but not limited to a car, a crossover, a truck, a van, a sports-utility-vehicle (SUV), and a recreational vehicle (RV) may be configured to tow a boat trailer. The tow vehicle connects to the trailer by way of a trailer hitch. In some examples, the tow vehicle is attached to a boat and a driver of the tow vehicle may back up along a downwardly-sloped surface towards the water to release or attach the boat. In this case, it is desirable for the tow vehicle to include a boat launch control system capable of, among other things, determining when the tow vehicle and connected trailer have sufficiently placed the boat in a body of water such that continued reversing of the tow vehicle may cease. Once the system determines that the boat is suitably positioned in the water, the system instructs a vehicle user interface to inform the driver to discontinue driving in reverse and place the tow vehicle in park or otherwise drive forwardly away from the body of water. In addition, or in the alternative, the system instructs a drive system of the vehicle to autonomously apply the brakes to hold the vehicle at standstill and/or drive forwardly from the water. The boat launch control system instructs the drive system of the vehicle to apply failsafe braking to hold the vehicle at standstill so that the driver may exit the vehicle and disconnect and/or displace the boat from the trailer, for subsequent forward maneuvering of the tow vehicle.

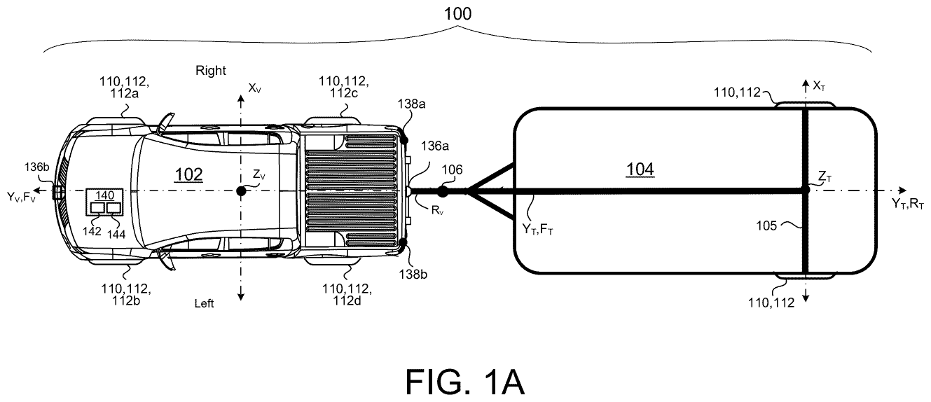

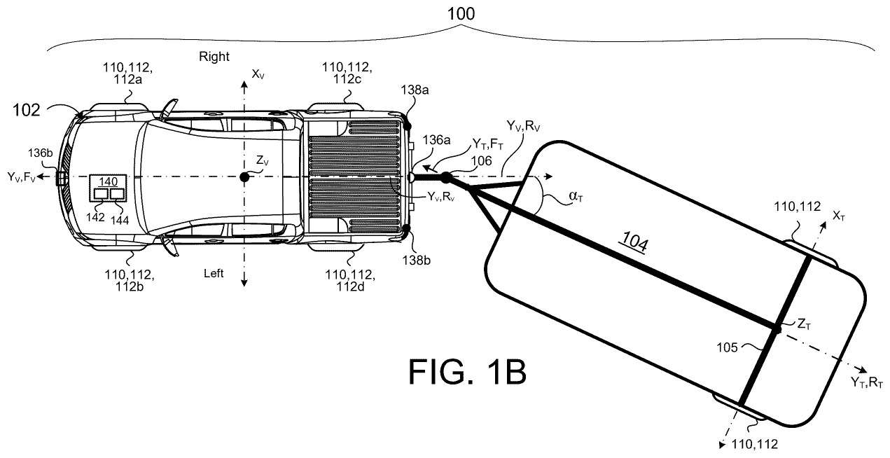

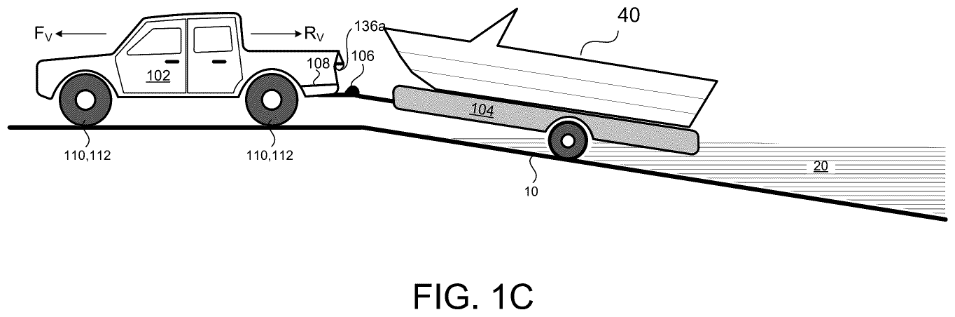

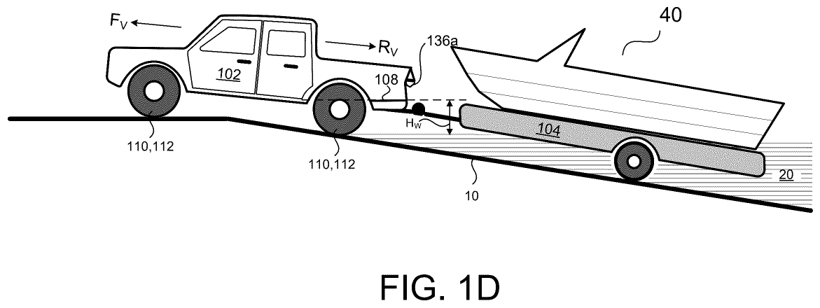

Referring to FIG. 1A-1D and 2, in some implementations, a vehicle-trailer system 100 includes a tow vehicle 102 hitched to a trailer 104 by way of a hitch 106. The tow vehicle 102 includes a drive system 110 associated with the tow vehicle 102 that maneuvers the tow vehicle 102 and thus the vehicle-trailer system 100 across a road surface 10 based on drive maneuvers or commands having x, y, and z components, for example. As shown, the drive system 110 includes a front right wheel 112, 112a, a front left wheel 112, 112b, a rear right wheel 112, 112c, and a rear left wheel 112, 112d. In addition, the drive system 110 may include wheels (not shown) associated with the trailer 104. The drive system 110 may include other wheel configurations as well. The drive system 110 includes other components (not shown) that are in communication with and connected to the wheels 112 that allow the tow vehicle 102 to move, thus moving the trailer 104 as well. The drive system 110 may also include a brake system 114 that includes brakes 116 associated with each wheel 112, 112a-d, where each brake 116 is associated with a wheel 112a-d and is configured to slow down or stop the wheel 112a-n from rotating. In some examples, the brake system 114 is connected to one or more brakes 116 supported by the trailer 104. The drive system 110 may also include an acceleration system that is configured to adjust a speed of the tow vehicle 102 and thus the vehicle-trailer system 100, and a steering system that is configured to adjust a direction of the tow vehicle 102 and thus the vehicle-trailer system 100. The vehicle-trailer system 100 may include other systems as well.

The tow vehicle 102 may move across the road surface 10 by various combinations of movements relative to three mutually perpendicular axes defined by the tow vehicle 102: a transverse axis X_{V}, a fore-aft axis Y_{V}, and a central vertical axis Z_{V}. The transverse axis X_{V}, extends between a right side R and a left side of the tow vehicle 102. A forward drive direction along the fore-aft axis Y_{V} is designated as F_{V}, also referred to as a forward motion. In addition, an aft or rearward drive direction along the fore-aft direction Y_{V} is designated as R_{V}, also referred to as rearward motion. In some examples, the tow vehicle 102 includes a suspension system (not shown), which when adjusted causes the tow vehicle 102 to tilt about the X_{V} axis and or the Y_{V} axis, or move along the central vertical axis Z_{V}. As the tow vehicle 102 moves, the trailer 104 follows along a path of the tow vehicle 102. Therefore, when the tow vehicle 102 makes a turn as it moves in the forward direction F_{V}, then the trailer 104 follows along.

Moreover, the trailer 104 follows the tow vehicle 102 across the road surface 10 by various combinations of movements relative to three mutually perpendicular axes defined by the trailer 104: a trailer transverse axis X_{T}, a trailer fore-aft axis Y_{T}, and a trailer central vertical axis Z_{T}. The trailer transverse axis X_{T}, extends between a right side R and a left side of the trailer 104, for example, along the trailer axle 105. A forward drive direction along the trailer fore-aft axis Y_{T} is designated as F_{T}, also referred to as a forward motion. In addition, a trailer aft or rearward drive direction along the fore-aft direction Y_{T} is designated as R_{T}, also referred to as rearward motion. Therefore, movement of the vehicle-trailer system 100 includes movement of the tow vehicle 102 along its transverse axis X_{V}, fore-aft axis Y_{V}, and central vertical axis Z_{V}, and movement of the trailer 104 along its trailer transverse axis X_{T}, trailer fore-aft axis Y_{T}, and trailer central vertical axis Z_{T}. Therefore, when the tow vehicle 102 makes a turn as it moves in the forward direction F_{V}, then the trailer 104 follows along. While turning, the tow vehicle 102 and the trailer 104 form a trailer angle α_{T} being an angle between the vehicle fore-aft axis Y_{V} and the trailer fore-aft axis Y_{T}.

The tow vehicle 102 may include a user interface 120, such as a display. The user interface 120 is configured to display information to the driver. In some examples, the user interface 120 is configured to receive one or more user commands from the driver via one or more input mechanisms or a touch screen display and/or displays one or more notifications to the driver. In some examples, the user interface 120 is a touch screen display. In other examples, the user interface 120 is not a touchscreen and the driver may use an input device, such as, but not limited to, a rotary knob or a mouse to make a selection. The user interface 120 may provide the driver with messages or instructions as discussed further below.

In some implementations, the tow vehicle 102 includes a sensor system 130 to provide sensor system data 132 that may be used to determine one or more measurements associated with an environment of the tow vehicle 102, the trailer 104, and/or objects surrounding the tow vehicle 102, such as a body of water. In some examples, the tow vehicle 102 may be autonomous or semi-autonomous. The sensor system 130 may include different types of sensors that may be used separately or with one another to create a perception of the tow vehicle's environment or a portion thereof that is used by the vehicle-trailer system 100 to determine measurements and/or identify object(s) in its environment and/or in some examples autonomously drive and make intelligent decisions based on objects and obstacles detected by the sensor system 130. In some examples, the sensor system 130 is supported by the rear portion of the tow vehicle 102 and provides sensor system data 132 associated with object(s) and the trailer 104 positioned behind the tow vehicle 102. In some examples, the sensor system 130 provides sensor system data 132 for facilitating a boat launch into a body of water. The sensor system 130 may include sensor(s) 136, 138 positioned on the rear vehicle bumper 108 for, among other things, determining or estimating a location of a water line of a boat 40, a water surface level, and/or an angle formed between a boat front and the water surface level.

In some implementations, the sensor system 130 includes one or more imaging devices 136, 136a-n, such as camera(s). The one or more cameras 136, 136a-n capture images of an environment of the tow vehicle 102. In some examples, a rear camera 136a is positioned on a rear portion of the tow vehicle 102 and is configured to capture images 132b of the ground 10, among other things, such that when the tow vehicle 102 is approaching a body of water 20, the rear camera 136a captures images of the water. Cameras 136a, 136b may each be a monocular camera or a stereo camera, for example.

In some implementations, the sensor system 130 includes other sensors 138, 138a-n such as, but not limited to, radar, sonar, LIDAR (Light Detection and Ranging, which can entail optical remote sensing that measures properties of scattered light to find range and/or other information of a distant target), LADAR (Laser Detection and Ranging), ultrasonic sensors, etc. The other sensors 138, 138a-n may be positioned on a rear portion of the tow vehicle 102 such that when the tow vehicle 102 is approaching the water 20, the other rear sensors 138 capture sensor data 132c for detecting the boat positioned on the trailer 104, features of the boat, or water surface level with respect to the trailer 104 and/or the trailered boat.

The sensor system 130 is especially useful for receiving information of the environment or portion of the environment of the tow vehicle 102 and for increasing safety in the vehicle-trailer system 100 which may operate by the driver or under semi-autonomous or autonomous conditions.

The drive system 110, the user interface 120, and the sensor system 130 are in communication with a vehicle controller 140 that includes a computing device (or data processing hardware) 142 (e.g., central processing unit having one or more computing processors) in communication with non-transitory memory or hardware memory 144 (e.g., a hard disk, flash memory, random-access memory) capable of storing instructions executable on the computing processor(s)). In some example, the non-transitory memory 144 stores software instructions that when executed on the computing device 142 cause the vehicle controller 140 to provide a signal or command 146 to facilitate a safe boat launch, including a command to stop or otherwise maneuver the tow vehicle 102 when the vehicle controller 140 detects that the tow vehicle 102 has placed the trailered boat in a sufficient amount of water. As shown, the vehicle controller 140 is supported by the tow vehicle 102; however, the vehicle controller 140 may be separate from the tow vehicle 102 and in communication with the tow vehicle 102 via a network (not shown).

The vehicle controller 140 executes a boat launch trailer control system 150 that receives sensor system data 132 from the camera(s) 136 and/or other sensors 138. The boat launch trailer control system 150 processes the sensor system data 132 and based on the processed sensor system data 132, the boat launch trailer control system 150 determines that the vehicle controller 140 should send instructions to the tow vehicle driver for maneuvering the tow vehicle 102 as part of the boat launch operation, and/or to the drive system 110 (e.g., the brake system 114) causing the brakes 116 to engage and preventing the tow vehicle 102 from continuing to move in the reverse direction towards or into the water 20.

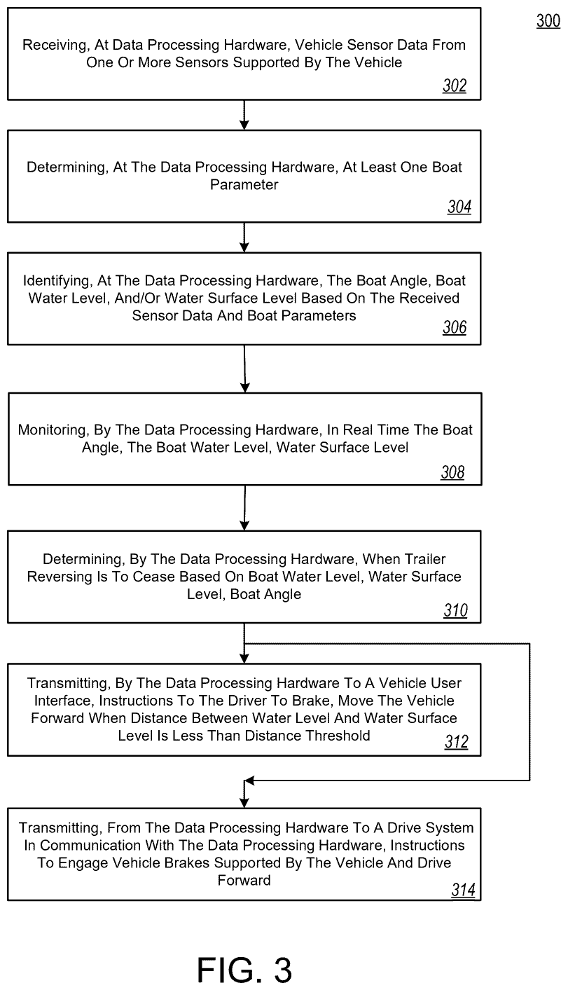

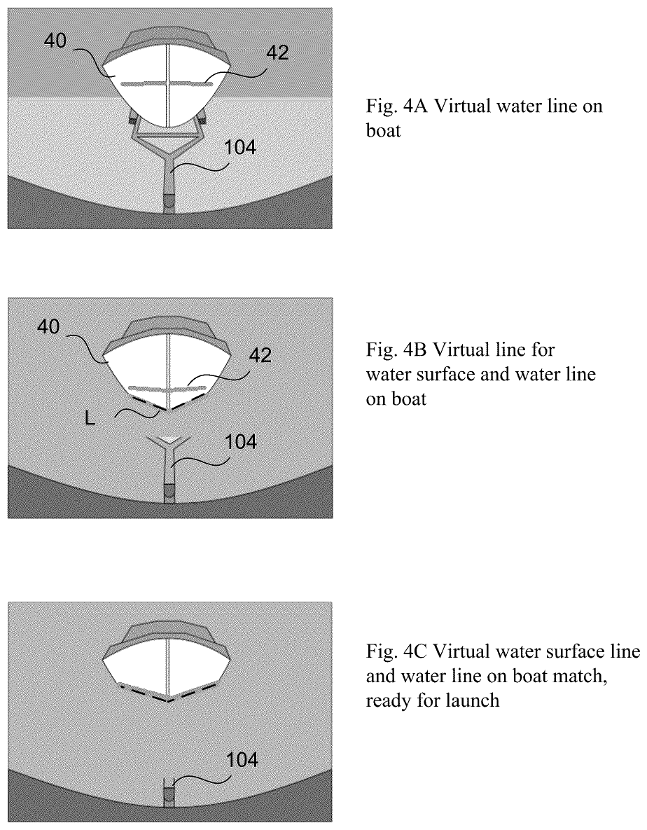

With continued reference to FIG. 2, the boat launch trailer control system 150 includes a boat parameter detection module and/or algorithm 152 which generally receives the image data 132b from camera 132a and optionally sensor data 132c, and identifies at least one boat parameter for use in determining when the trailered boat 40 is in a sufficient amount of water such that continued reversing of the tow vehicle 102 is unnecessary and potentially damaging to the tow vehicle 102. In one implementation, the boat parameter detection module 152 identifies, determines or infers one or more parameters of the boat 40 from boat representations in the image data 132b from which a location of a water line 42 corresponding to the boat 40 is estimated. The boat's water line 42 refers to the water surface level along the boat 40 when the boat is floating in open water, separate from the trailer 104. The water line 42 may be based on, for example, boat parameters such as the type of boat for boat 40, the size and/or shape of the hull of the boat 40, and/or a visual identification of the water line 42 as depicted in the image data 132b. Specifically, some boats may include a marker along the front hull of the boat corresponding to the water line and the identification of the marker may be used in estimating the location of the water line 42. The marker may be used in defining a region of interest and/or starting point for estimating the location of the water line 42. The water line 42 may be depicted in an image displayed to the tow vehicle owner, as shown in FIGS. 4A-4B and 5A-5B and discussed in further detail below.

It is understood that the estimated location of the water line 42 of boat 40 may be based on other factors or parameters in addition to the boat parameters discussed above. The boat parameter detection module 152 may receive user input via the user interface 120 concerning additional factors or parameters which are not otherwise discernable from the image data 132b. For example, the user may provide boat loading information via the user interface 120. The provided boat loading amount may be added to an estimate of the weight of the boat 40.

In one implementation, the boat parameter detection module 152 may use artificial intelligence (AI) and/or machine learning to estimate the location of the water line 42 of the boat 40 based at least in part upon the image data 132b. For example, a trained neural network 156 and/or an AI model of the boat 40, that is generated using AI and/or machine learning, may receive the image data 132b and output the estimated water line 42 therein. The neural network 156 may be trained using image data of any of a number of different boats. The neural network 156 and/or AI model may estimate the location of the water line 42 based on the boat type, hull size and/or shape, etc.

In another implementation, the boat parameter detection module 152 may utilize computer vision to estimate the location of the waterline 42 of the boat 40. Specifically, the boat parameter detector 152 extracts one or more parameters of the representation of the boat 40 in the image data 132b, such as boat type, hull size and/or shape, etc., compares the one or more extracted parameters to a database, lookup table or the like of boat parameters, and identifies a best match of the comparison for use in determining or estimating the location of the water line 42 of boat 40.

The estimated location of the water line 42 of boat 40 is used in at least one example embodiment to determine when continued movement in the reverse direction of the tow vehicle 102 towards and/or into the water should cease.

Specifically, the boat launch trailer control system 150 may include a water surface level detection module and/or algorithm 154 which identifies the surface level of the water depicted in the image data 132b from camera 136a. The water surface level detection module 154 may be implemented using the AI and/or the neural network that identifies the water surface level based on the image data 132b. In another implementation, computer vision may be used to identify the water surface in the image data 132b.

The water surface level may be detected by the water surface level detection module 154 using any one of a number of approaches. For instance, the water surface level detection module 154 may utilize edge detection and contour analysis. Specifically, edge detection may be used to identify the boundary between the boat 40 and the surface of the water 20. In an implementation, a Canny edge detection algorithm identifies the boat-water boundary. Further, a contour detection algorithm may be employed to find contours in the edge-detected image for locating the bottom edge of the hull of the boat 40. This may include selecting the contour that represents or best represents the interface or intersection between the boat 40 and the surface of the water 20. In addition, a line or curve through the points in the image data 132b that are along the located bottom edge of the boat hull may be identified in estimating the water surface level.

Alternatively, the water surface level may be detected using a texture and/or gradient based analysis. Specifically, the water surface level detection module 154 may employ texture analysis using descriptors on the received image data 132b. This analysis analyzes the texture differences between the representation of the hull of the boat 40 in the image data 132b and the water surface level using texture descriptors, such as Local Binary Patterns (LBP). Differences in texture are used in distinguishing the boat hull representation from the water surface representation in the image data 132b when color differences between the boat hull and water surface representations are negligible. Computing the magnitude and direction of an image gradient serves to identify areas of the image data 132b with substantial changes in intensity. The boundary between the boat 40 and the surface level of the water 20 may show distinct gradient patterns which may be used to identify the water surface level. Peaks in the gradient magnitude along the boat-water boundary of the image data 132b may additionally or alternatively used to approximate the position of the water surface level.

In an example embodiment of the boat launch trailer control system 150 which utilizes the trained neural network and/or AI-generated model 156 discussed above, the trained neural network and/or AI-generated model 156 may utilize semantic segmentation and classification to determine the water surface level. One or more deep learning models may be trained specifically to segment the boat 40 and the water 20 in the image data 132b. The deep learning model may have an architecture or framework such as, for example, Segformer, U-Net, Mask R-CNN (Region-based Convolutional Neural Network). After segmentation of the image data 132b, the trained neural network/model 156 extracts the water surface level from the generated segmentation mask to identify the boundary between the boat 40 and the surface level of the water 20.

It is understood that additional AI-based techniques using semantic segmentation and classification may complement the approaches discussed above or be used in combination to improve accuracy. Such additional techniques may include machine learning classification in which training classifiers on extracted features from image patches of the image data 132b are used to distinguish between the boat 40 and the water 20. A modified edge detection algorithm with focused regions of interest in the image data 132b reduce false detections. Advanced techniques such as graph cut segmentation and superpixel segmentation may be utilized to enhance segmentation accuracy.

It is understood that incorporating data from depth sensors (not shown) or a stereo camera of the vehicle to provide depth information aids in distinguishing between the boat 40 and the water 20.

It is further understood that the boat parameter detection module 152 may utilize the same approaches, techniques and/or frameworks discussed above for detecting the water surface level by the water surface level detection module 154 in detecting the representation of the boat 40, the boat parameters and/or the water line 42 in the image data 132b.

The boat launch trailer control system 150 may provide to the user the estimated location of the water line 42 and the determined water surface level. In this implementation, an overlay is created by the boat launch trailer control system 150 in which the water line 42 and the water surface level are highlighted in a display of the image data 132b on the display component of the user interface 120. Upon being provided a visual display of the image data with overlaid the water line and water surface level highlighted, the tow vehicle user may determine whether to cease reverse maneuvering of the tow vehicle if the distance between the water line 42 and the water surface level is deemed by the user to be sufficiently small such that the user elects to stop the tow vehicle 102. The system may change the highlighting in the overlay at a point in time at which the water surface level approaches or meets the water line 42, to assist the tow vehicle driver in determining when to cease rearward travel. This implementation advantageously provides a relatively small amount of processing by the boat launch trailer control system 150. Once the location of the water line 42 is estimated for boat 40, the water line 42 may be saved in system memory 144 for use in future boat launches with boat 40, following a verification by the system that the same boat 40 is being used in such future boat launch.

In a second implementation, a distance calculator/risk assessment module or algorithm 158 calculates the distance between the estimated location of the water line 42 and the detected water surface level, and determines whether the calculated distance is sufficiently small to warrant ceasing of trailer reversing toward or into the water. In this implementation, the distance between the water line 42 and the water surface level may be in units of pixels of the images forming the image data 134b. Stopping reverse trailer motion may be warranted if the calculated distance is less than a predetermined value. It is understood that the decision to cease reverse trailer travel may be based upon other factors, such as the amount of the downwardly sloped surface 10 on which the tow vehicle 102 and trailer 104 are traveling. The downward slope may be determined using the image data 132b and/or map information maintained by the boat launch trailer control system 150 so that the effect of continued reverse travel by the tow vehicle 102 and connected trailer 104 can be accurately determined. Further, the distance and its rate of change may allow the distance calculator/risk assessment module 158 to predict a time when continued reverse tow vehicle travel should cease. In this implementation, the AI model and/or neural network 156 may be used in calculating the distance between the water line 42 and the water surface level, and/or determining whether the continued reverse travel of the tow vehicle 102 and trailer 104 is warranted, based upon the calculated distance.

In one implementation, the images captured by the rear camera 136a are displayed on the display monitor of the user interface 120, and the user specifies the location of the water line 42 using the touch screen feature of the display monitor.

The boat launch trailer control system 150 may be utilized with tow vehicle 102 being semi-autonomous. The control system 150 may include a trailer maneuver command generator module or algorithm 160 which generates commands to assist the tow vehicle driver in maneuvering the tow vehicle 102 during a boat launch operation. In one embodiment, the trailer maneuver command generator 160 sends instructions to the display unit forming the user interface 120 which visually directs the driver to continue reverse travel of the tow vehicle 102 and trailer 104 towards or into the water, to stop the tow vehicle 102 to discontinue reverse travel, or to travel forward to move away from the water. For example, upon the distance calculator/risk assessor module 158 determining that continued reversing of the tow vehicle 102 should cease, the trailer maneuver command generator 160 sends to the display unit of the user interface 120 a command to inform the driver to stop the tow vehicle 102 and optionally proceed in the forward direction. It is understood that in addition or in the alternative to providing a visual instruction to the driver, an audible and/or haptic instruction may be provided to the driver. In this regard, the user interface 120 may include a speaker which is configurable to provide any one of the instructions discussed hereinabove with respect to the visual driver instructions.

As discussed, the boat parameter detector 152 estimates the location of the water line 42 of boat 40, for use in determining the distance to a determined water surface level. In addition, or in the alternative, the boat parameter detector 152 determines the boat angle formed between the front end portion of the boat 40 and the water surface level. The boat angle may be seen to be the angle formed between a longitudinal axis of the boat 40 and the water surface level determined by water surface level detector 154. This boat angle may be used in determining by the risk assessor module 158 whether or not the reverse movement of the trailer 104 should continue. Specifically, the risk assessor module 158 may determine that continued reverse movement by the tow vehicle 102 and the trailer 104 may cease once the boat angle corresponding to the boat 40 and the water surface level being largely parallel to each other, which may be between 5 degrees and 0 degrees.

In addition or in the alternative, the boat parameter detector 152 may determine in the image data 134b the position of the representation of the boat 40, and determines that the tow vehicle movement in the reverse direction may cease based upon, for example, the detection of an amount of change of position of the representation of the boat 40 in the image data. Further, the position of the representation of the trailer 104 in the image data may be determined, and the distance calculator/risk assessor module 158 determines the distance between the boat representation and the trailer representation, wherein if this distance exceeds a predetermined amount, thereby indicating that the front of the boat 40 is floating on the water unsupported by the trailer 104, the distance calculator/risk assessor 158 determines that continued reversing of the tow vehicle 102 and trailer 104 should cease.

The boat launch trailer control system 150 may additionally detect that the trailer coupler and the tow ball of the tow vehicle 102 being submerged, which may indicate that the trailer 104 is too far into the water 20. Upon such detection, the system 150 sends an instruction to the user interface 120 to cause the display of the user interface to direct the tow vehicle driver to cease reverse movement.

In the event the tow vehicle 102 is fully autonomous, the boat launch trailer control system 150 determines whether or not the tow vehicle 102 and connected trailer 104 should cease movement in the reverse direction, as described above, and the trailer maneuver command generator 160 generates and sends instructions to the drive system 110 of the tow vehicle 102 which, when executed by the drive system, maneuvers the tow vehicle 102 accordingly. In this way, the tow vehicle 102 is enable to fully autonomously support a boat launch operation.

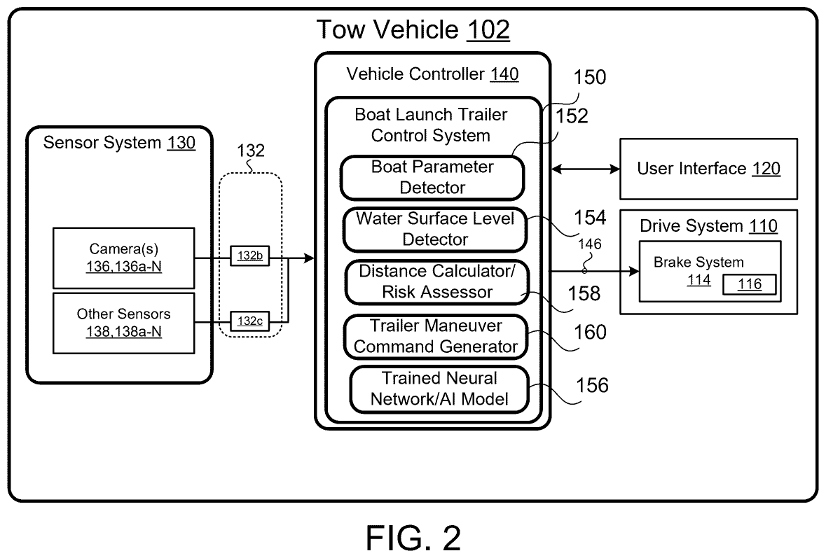

FIG. 3 illustrates a flowchart of a boat launch operation according to one or more embodiments. At 302, data processing hardware of vehicle controller 140 receives image data 134b from rearward facing camera 136a. The data processing hardware determines at 304 at least one parameter of the boat 40 disposed on the trailer 104. The determined parameters may include boat type, boat shape and/or dimensions (e.g., height), a representation of a water line in the image data 134b, etc. The data processing hardware determines at 306 the water line, the boat angle, and/or the water surface level, which the system continues to monitor at 308 as the tow vehicle 102 and trailer 104 move in the reverse direction, by continuously determining the distance between the water surface level and the water line 42, and/or the boat angle. In some embodiments, upon the data processing hardware determining at 310 that this distance is less than a predetermined amount, the data processing hardware at 312 transmits instructions to the user interface 120 to, for example, visually direct the tow vehicle driver to cease reverse movement of the tow vehicle 102. Prior to the distance falling below such predetermined amount, the data processing hardware may transmit instructions to the user interface 140 to direct the tow vehicle driver to continue maneuvering the tow vehicle 102 in the reverse direction. In addition and/or in the alternative to providing directions to the tow vehicle driver, at 314 the data processing hardware may transmit instructions to the drive system 110 of the tow vehicle 102 to cause the tow vehicle 102 to cease reverse maneuvering when the distance falls below the predetermined level amount.

FIGS. 4A-4C illustrate the use of the vehicle display forming at least part of the user interface 120 during a boat launch operation. FIG. 4A depicts an image displayed on the vehicle display using the image data 134b at an early part of the boat launch operation in which the tow vehicle 102 and trailer 104 are moving in the reverse direction towards the water but before a majority of the trailer being submerged. At this point, the system determines the water line 42 and depicts it in the displayed image as an overlay. As the trailer continues in the reverse direction, the display shows a majority of the trailer 104 is submerged and the water surface level L is highlighted (in this case, as dashed line segments) as part of the overlay. As shown, the distance between the water line 42 and the water surface level L is non-zero. Further reverse trailer movement results in a majority of the trailer 104 being submerged with the water surface level L meeting or slightly surpassing the water line 42, as shown in FIG. 4C. At this point, with the water surface level L meeting the water line 42, the system determines that the boat 40 is at a sufficient depth in the water such that the trailer 104 no longer needs to move in the reverse direction.

FIGS. 5A-5C further illustrate use of the vehicle display during a boat launch operation. In FIG. 5A, a majority of the trailer 104 is submerged but the water surface level L is distanced from (i.e., below) the overlaid water line 42. The distance between the water line 42 and the water surface level L may be measured along a centerline of the hull, as shown. FIG. 5B illustrates a display similar to FIG. 4B which shows an instruction to the driver to stop movement of the tow vehicle 102 in the reverse direction, that the boat 40 is suitably positioned to be launched from the trailer 104. FIG. 5C depicts the displayed image when the trailer 104 undesirably continues to move in the reverse direction after the direction is given to stop the vehicle. In this case, trailer coupler and vehicle tow ball are submerged, and the direction provided to the driver is to stop and move the trailer 104 in the forward direction.

In accordance with one or more embodiments, launch readiness detection for boat launch uses hull pitch angle, mask-based submersion metrics, and/or GPS information. A boat's launch-ready state may be detected from video by combining (i) a hull-pitch angle measured relative to the image horizon, (ii) an overlap ratio between a lower-half hull region and a water region, and (iii) a submersion depth ratio measured from the boat's hull keel. For each video frame, a segmentation model produces instance masks for hull and water, which are resized to image coordinates to determine the hull's top and bottom rows (y_top, y_bot) and define the lower-half band (rows y∈[(y_top+y_bot)/2, y_bot]). A water region is formed from water masks and/or filled water bounding boxes. The system computes (a) overlap area ratio=area(lower-half∩water)/area(lower-half), (b) depth ratio=(y_bot−y_first_water_in_lower_half)/(y_bot−y_top), where y_first_water_in_lower_half is the smallest row inside the lower-half containing any water pixel, and (c) hull-pitch angle by fitting a line to hull-bottom pixels within a narrow band near y_bot and comparing that line's angle to the image horizon (either assumed horizontal for a fixed camera or estimated via horizon detection). A launch-ready state is declared when the angle change (Δθ from a dry baseline) and the two mask-based ratios exceed their thresholds for N consecutive frames.

As is known in the art, an image horizon, also known as the horizon line, is the horizontal line in an image where the sky appears to meet land or a body of water. And a segmentation model divides an image into regions or segments, assigning a label to each pixel to define what it represents.

“First water in lower half,” as used herein, means the first place water is reliably detected touching the hull somewhere in the bottom 50% of the hull's height. The bottom half refers to the lower half of the hull, that is, less than half way up the hull from the keel (y_bot) to the top of the hull (y_top).

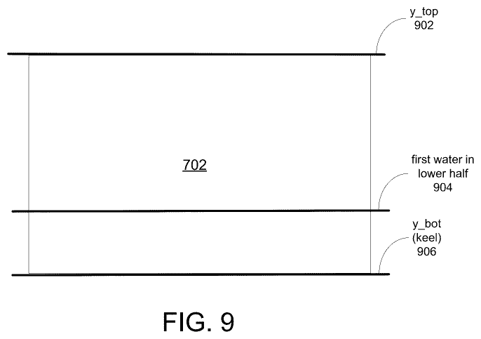

In FIG. 9, the first water contact is shown not right at the keel, but a little higher up, about 30% of the distance from y_bot toward y_top. This may happen because the keel is usually the very lowest point of the hull, and depending on the boat's shape and the camera view, the first visible waterline may appear slightly above the keel. For example, the keel may already be submerged but not visible due to shadows, trailer parts, or segmentation limits. The system detects the waterline touching the hull a bit higher up than the keel, in the example depicted in FIG. 9, around 30% of the way up the height of the hull.

Stated differently, FIG. 9 shows that “first water in lower half” doesn't necessarily mean the exact keel line. Instead, “first water in lower half” means the first reliable detection of water against the hull in the lower region. In FIG. 9, that happens about one-third of the way up the height of the hull from the keel. The example value of approximately 30%, which is depicted in FIG. 9, is simply a way of illustrating the concept in the figure. In practice, the percentage could be different depending on the boat, the ramp, the viewing angle, or the sensor. In accordance with one or more embodiments, the waterline is detected within the lower half of the hull.

With respect to the phrase, “N consecutive frames,” N may be set to 5 frames (about 0.17 seconds at 30 fps). In other cases, N could be 3 frames to allow faster detection, or 10 frames to increase confidence. Other suitable values for N may also be used. The choice of N may vary depending on frame rate, boat motion, and environmental noise

In addition to the vision signals (hull-pitch angle, hull-water overlap, and depth), one or more embodiments may use the Global Positioning System (“GPS”) to recognize when a launch is likely happening. The system may (a) check that the vehicle is inside a ramp geofence (within X meters of a known ramp or shoreline point) and (b) detect backing-down motion toward the water using GPS course-over-ground and speed (e.g., speed<˜5 mph and the motion vector aligned with the ramp direction, or decreasing distance to the water line). When both conditions hold, the system may enter a “launch sequence” state that enables/weights the visual checks. Such a GPS gate prevents false triggers away from ramps and provides redundancy if water recognition is briefly unreliable. A determination of a boat-launch-ready state will typically still involve the visual thresholds (angle Δθ, overlap %, depth) to be met for N consecutive frames.

With respect to a ramp geofence, “X meters” may refer to an expected value of 30-50 meters. In other cases, X may be 10-15 meters under high-accuracy positioning, or 100-150 meters in environments with degraded GPS accuracy (multipath or tree cover). Other suitable ranges for X meters may also be used.

If GPS is unavailable or low quality (HDOP/accuracy>threshold), the system may disregard GPS data and use the vision-based thresholds.

In summary, the hull-pitch (Δθ) is an angle of a best-fit line through hull-bottom pixels near y_bot, measured vs. the image horizon and is compared to a dry (on-trailer) baseline. The overlap area ratio is the ratio of the area of the intersection of (the lower-half hull AND the water)/area of (the lower-half hull). The depth ratio: (y_bot−y_first_water_in_lower_half)/(y_bot−y_top). And the decision rule is: trigger “Launch Ready” when (in geofence AND backing-down per GPS) AND Δθ≥τθ AND overlap≥τa AND depth≥τd for N consecutive frames.

In accordance with one or more embodiments, the system determines that the boat is floating when three conditions hold true for several frames in a row (for example, 3-10 frames depending on camera speed) as follows. The change in hull pitch angle (Δθ) is bigger than a set threshold τθ (for example, 1-3°). The fitted line near the hull bottom overlaps enough with the expected shape, more than τa (for example, 60-80%). The measured water depth under the hull is greater than τd (for example, approximately 1-2 feet). These thresholds may be chosen based on test data and may change depending on boat type, trailer, and ramp conditions. And other suitable values for these thresholds may also be used.

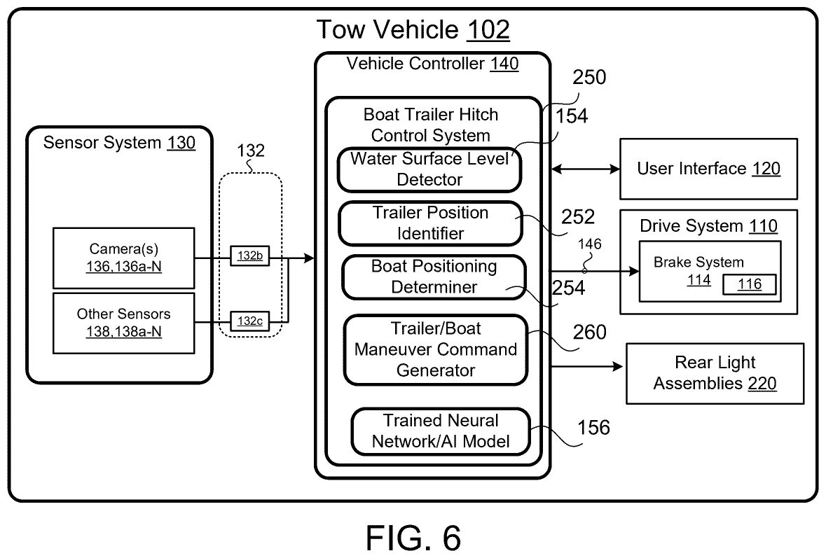

FIG. 7 depicts best fit lines, the angles of which, relative to the image horizon, are referred to as θ_dry and θ_floating, which are used for calculating the hull-pitch-angle signal. FIG. 7 depicts a hull mask 702, a best-fit line 706 through pixels near the hull's bottom edge, while the boat is on the trailer and not yet floating in the water, and a best-fit line 708 through pixels near the hull's bottom edge, while the boat is floating in the water. The system measures the best-fit line's angle relative to the image horizon and compares it to a dry, on-trailer baseline angle. When the boat starts to float, the angle change, Δθ, is one of the three cues in the “Launch Ready” decision. In this context, “near the hull's bottom edge” refers to a limited region of pixels corresponding to the lowest portion of the hull mask, for example within a vertical offset of 5 -15 pixels, or the lowest 5-10% of pixels in the mask. Other suitable ranges may also be used. This region is used to determine a best-fit line representing the hull's keel orientation in both the trailer and floating states. A lower portion 704 of the hull mask is a region of interest near the hull's bottom edge). The hull mask 702 is the segmented region of the boat hull in the camera view.

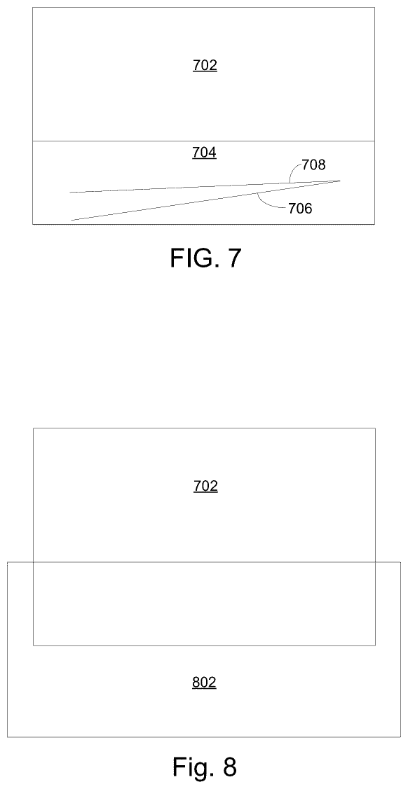

FIG. 8 depicts a percentage of the hull's lower half that overlaps with the water. FIG. 8 depicts the hull mask 702, a water mask 802, and a percentage of the hull's lower half overlapping the water. Using a percentage of the bottom portion of the hull's lower half provides improved stability over using the entire hull height, since the lower hull is more linear and less affected by visual noise or curvature.

FIG. 9 depicts first water in lower half 902 approximately 30% of the way from the bottom of the keel (y_bot) 904 to the top of the hull (y_top) 906.

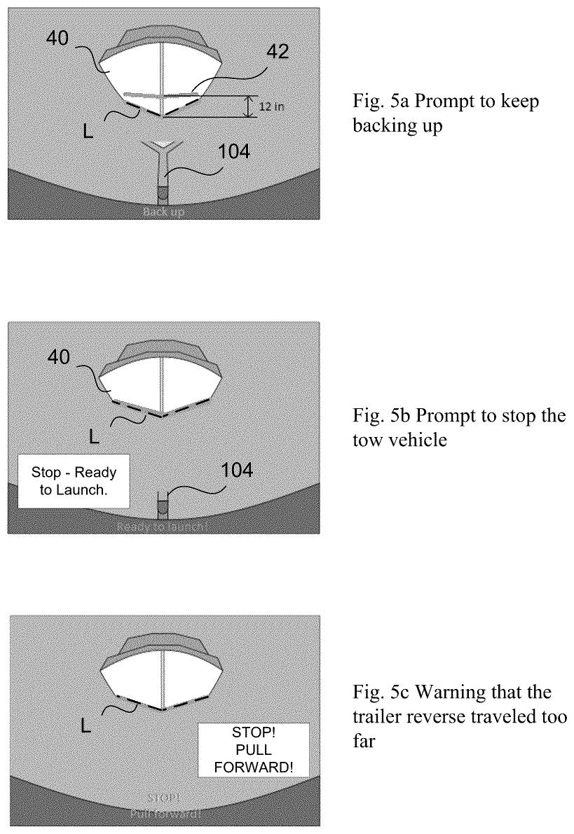

In another embodiment, the vehicle controller 140 executes a boat trailer hitch control system 250 to assist the tow vehicle driver in securing the boat 40 onto the trailer 104 after boating activities are complete. Referring to FIG. 6, the boat trailer hitch control system 250 allows for appropriate positioning of the tow vehicle 102 to receive the boat 40 while also assisting the boat 40 to be maneuvered onto a stationary, appropriately-positioned trailer 104.

As to positioning the tow vehicle 102 so that the boat 40 may be mounted onto the trailer 104, the boat trailer hitch control system 250 may include a trailer position identifier module and/or algorithm 252 which utilizes the water surface level detector 154 discussed above to determine the water surface level. The boat launch trailer control system 150 may, at the time of launching the boat 40 from the trailer 104, save the position of the trailer 104 relative to the detected water surface level. This position of the trailer 104 may be made by identifying the portion of the trailer 104 that is visible in the image data 132b captured at the time of the boat launch. The intent is to position the trailer 104 at the same depth in the water 20 when receiving the boat 40 as the trailer depth when the boat 40 was launched. By having saved in system memory 144 the position of the trailer 104 relative to the water surface level when the boat 40 was previously launched from the trailer 104, the saved trailer position may be used by the trailer position identifier 252 in controlling the tow vehicle 102 so that the trailer 104 enters the appropriate depth in the water 20, as measured relative to the current water surface level detected and/or by monitoring the portion of the trailer 104 that is visible and/or above the water surface level, for receiving the boat 40. A trailer/boat maneuver command generator 260 may be used for providing direction to the tow vehicle driver as the driver maneuvers the tow vehicle 102 in the reverse direction, and/or for controlling at least part of the drive system 110 for such trailer maneuvering in the reverse direction. This direction or control may be based at least in part upon the determined water surface level. Once the trailer 104 is suitably positioned to receive the boat 40, the tow vehicle is parked at that position so as to allow the tow vehicle driver to then pull or drive the boat 40 onto the trailer 104.

Concerning positioning of the boat 40 relative to the parked trailer 104, the camera 136a continues to be used in providing directions to the boat driver until the boat 40 is positioned over the trailer 104. In one implementation, the boat trailer hitch control system 250 includes a boat position determining module or algorithm 254 which receives the image data 132b from rear camera 136a and identifies a representation of the trailer 104 and a representation of the boat 40 in the image data. The trailer/boat maneuver command generator 260 determines the commands to provide to the boat driver for positioning the boat 40 over the trailer 104, based upon the identified positions of the trailer 104 and the boat 40 in the image data 132b. In this implementation, the rear light assemblies of the tow vehicle 102 may be used for communicating the commands to the boat operator. For instance, the trailer/boat maneuver command generator 260 receives input from the boat position determining module 254 and generates a command(s) that is sent, directly or indirectly, to the rear light assemblies 220 of the tow vehicle 102. In one implementation, one rear light(s) from the rear light assemblies 220 may be illuminated to correspond to an instruction for the boat driver to move the boat 40 forwardly in a straight direction; another rear light(s) may be illuminated to correspond to an instruction for the boat driver to move the boat 40 forwardly to the right; another light(s) may be illuminated to instruct the boat driver to move the boat 40 forwardly to the left; another light(s) may be illuminated to instruct the boat driver to stop forward boat movement because the boat 40 is determined to be positioned over the trailer 104; etc. It is understood that the same light(s) be used differently to distinguish one boat driver instruction from another. For instance, a rear light of the tow vehicle may flash at increasing frequencies as the boat 40 approaches the trailer 104 and is illuminated without any flashing when the boat 40 is in its final position over the trailer 104.

Alternatively, application software loaded onto a hand-held device (e.g., mobile telephone, tablet or the like) that is in wireless communication with the vehicle controller 140 may provide a visual display of boat driver instructions instead of using the rear light assemblies 220.

It is understood that the boat trailer hitch control system 250 may utilize the same or a different neural network/AI model as used by the boat launch trailer control system 150, or may utilize computer vision in identifying water surface level, boat position, etc.

The boat trailer hitch control system 250 and the boat launch trailer control system 150 allow for boat launching and boat trailer mounting by a single person. In an example embodiment, the vehicle controller 140 executes the boat trailer hitch control system 250 and the boat launch trailer control system 150 so that the vehicle controller 140 facilitates a boat launch operation as well as a boat trailer hitching operation.

It is understood that modules of the boat trailer hitch control system 154 may utilize the same or similar approaches, techniques and/or frameworks discussed above for detecting the water surface level by the water surface level detection module 154 in detecting the position of the trailer 104 relative to the water surface level by the trailer position identifier module 252, and in detecting the position of the boat 40 relative to the parked trailer 104 by the boat positioning determination module 254.

This boat launch trailer control system 150 combines a camera with advanced AI algorithms to detect when it is the right time to start the boat launch process because it has a clear view of the area behind the vehicle, including the boat, water, trailer, and ramp. The camera monitors the boat and water angle. If the boat is on the water and it is parallel with the surface of the water, that means the boat is floating and it is the right time to start the launch.

The system works by capturing images of the water and boat from rear-view camera and analyzing these images using AI to detect water and boat and estimate the angle between water surface and the boat. If the boat is parallel to the surface of the water, the system could trigger different types of alerts and let the driver know that it is the right time to launch the boat.

### The System Operates This Way:

1. Preventive Safety Measures: Backing up the trailer can be difficult for many people, especially those with little experience, and typically requires a second person (spotter) to guide and mitigate this challenge. By detecting the right time to launch, the system provides an opportunity to take preventive actions to avoid the vehicle being submerged in water and risking the individual's life.
2. Automation and Efficiency: Leveraging AI allows for constant monitoring without the need for manual inspection and second person guidance, making the process more efficient and reliable. The AI can quickly analyze the video and alert the driver if it is the right time to launch.
   The alert can be an audio signal or a graphical overlay, such as for back up assist.
3. Automatic notification: The system can then pass a signal to the vehicle and the vehicle can then alert the driver/person of the right time.
4. Elimination of second person guidance.

This system is designed to offer peace of mind to drivers, ensuring that potential hazards can be addressed proactively before launching the boat.

The system generally performs two steps in facilitating a boat launch.

First step: Determine parameters for boat ready to launch. This can be done through a marking on the boat's water line or a model that infers parameters about the boat and estimates a water line. A third option is to use computer vision to match the boat to parameters in a database to get the waterline that way. The estimated (“virtual”) water line can then be drawn in the Camera overlay for the user to see.

Second step: To launch the boat, the distance between the water surface and the water line on the boat is detected.
1) In the simplest way we draw the edge of the water on the boat and the water line and let the user judge when both marks are lined up, this version does not need any additional processing besides the tracking of the virtual elements. See FIGS. 4A-4C.
2) An AI model is used to determine the distance between water surface and water line.
3) Computer vision is used to determine the distance between water surface and water line. For both (2) and (3) prompts are given to user in the style of instructions provided at a car wash (i.e., pull forward, stop and back up) also if the trailer hitch is no longer visible the user is too far in the water and is prompted to pull back out. see FIGS. 5A-5C.

The block diagram of the AI-powered boat launch assistant consists of several key components, each playing a role in the functionality of the system. Here is a breakdown of each of a number of blocks forming the system.

Camera 136a: This is the initial component of the system, responsible for capturing images of the water and the boat. The camera is equipped with high-resolution capabilities to ensure detailed images are obtained, which are advantageous for accurate analysis. It serves as the system's “eyes,” providing the raw data needed for assessing the water surface and boat angle.

AI Analysis Module: After the images are captured, they are sent to the AI Analysis Module (referred to above as the trained neural network and/or the AI model). This module uses advanced algorithms and machine learning techniques to analyze the images to detect two different categories-boat and water-then estimates the angle between boat and surface of the water. This module is the “brain” of the system, interpreting the data and classifying the scenarios mentioned earlier.

Risk Assessment Module 158: This module receives the detection information from AI Analysis module, informing the driver if it is the right time to launch the boat. It also informs the driver if it is too close to water and there is a risk of submerging into water.

Alert System/user interface 120: Based on the analysis conducted by the AI Analysis Module and Risk Assessment Module 158, the Alert System is activated when it is the right time to launch the boat. This system can notify the driver about the right launching time and other potential risks, enabling quick action to be taken. The Alert System is crucial for translating the system's findings into actionable insights and interventions.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus,” “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims.

1. A method for use in performing a boat launch operation with a tow vehicle, a connected trailer, and a boat positioned on the trailer, the method comprising:
receiving, at data processing hardware, image data from at least one camera supported by the vehicle as the tow vehicle and trailer move in a reverse direction towards a body of water;
determining, by the data processing hardware, a hull-pitch angle relative to an image horizon of the boat based upon the image data, an overlap ratio between a lower half of a hull of the boat and water into which the boat is being launched, and a submersion depth ratio measured from a hull keel of the boat; and
transmitting, by the data processing hardware, an instruction to a user interface of the vehicle or a drive system thereof to cease movement of the tow vehicle and trailer in the reverse direction based upon the hull-pitch angle relative to an image horizon, the overlap ratio between a lower half of the hull and water, and a submersion depth ratio measured from a hull keel of the boat all exceed respective predetermined thresholds for at least a predetermined number of consecutive image frames of the image data from the at least one camera.

2. The method of claim 1, further comprising using Global Positioning System information as a factor in determining whether the boat launch operation is happening.

3. The method of claim 2, wherein using Global Positioning System information further comprises determining whether the tow vehicle is inside a ramp geofence associated with a known boat-launch ramp or shoreline location.

4. The method of claim 2, wherein using Global Positioning System information further comprises using GPS course-over-ground and speed-over-ground to determine whether the tow vehicle is moving in reverse toward a water line.

5. The method of claim 1, wherein, for each video frame, a segmentation model produces a hull instance mask and a water instance mask, which are resized to image coordinates to determine a top row of the hull and a bottom row of the hull (y_top, y_bot) and defines a lower-half band of the hull (rows y∈[(y_top+y_bot)/2, y_bot]).

6. The method of claim 5, wherein a water region is formed from water masks and/or filled water bounding boxes.

7. The method of claim 6, wherein an overlap area ratio =area(lower-half∩water)/area(lower-half), a depth ratio=(y_bot−y_first_water_in_lower_half)/(y_bot−y_top), where y_first_water_in_lower_half is a smallest row inside the lower-half band of the hull containing any water pixel, and the hull-pitch angle is determined by fitting a line to hull-bottom pixels within a narrow band near y_bot and comparing that line's angle to the image horizon.

8. A system for facilitating a boat launch operation with a tow vehicle, a connected trailer, and a boat positioned on the trailer, the system comprising:
data processing hardware; and
memory hardware in communication with the data processing hardware, the memory hardware storing instructions that, when executed on the data processing hardware, cause the data processing hardware to perform operations comprising:
receiving, at data processing hardware, image data from at least one camera supported by the vehicle as the tow vehicle and trailer move in a reverse direction towards a body of water;
determining, by the data processing hardware, a hull-pitch angle relative to an image horizon of the boat based upon the image data, an overlap ratio between a lower half of a hull of the boat and water into which the boat is being launched, and a submersion depth ratio measured from a hull keel of the boat; and
transmitting, by the data processing hardware, an instruction to a user interface of the vehicle or a drive system thereof to cease movement of the tow vehicle and trailer in the reverse direction based upon the hull-pitch angle relative to an image horizon, the overlap ratio between a lower half of the hull and water, and a submersion depth ratio measured from a hull keel of the boat all exceed respective predetermined thresholds for at least a predetermined number of consecutive image frames of the image data from the at least one camera.

9. The system of claim 8, wherein the memory hardware stores instructions that, when executed on the data processing hardware, cause the data processing hardware to perform further operations comprising: using Global Positioning System information as a factor in determining whether the boat launch operation is happening.

10. The system of claim 9, wherein using Global Positioning System information further comprises determining whether the tow vehicle is inside a ramp geofence associated with a known boat-launch ramp or shoreline location.

11. The system of claim 9, wherein using Global Positioning System information further comprises using GPS course-over-ground and speed-over-ground to determine whether the tow vehicle is moving in reverse toward a water line.

12. The system of claim 8, wherein, for each video frame, a segmentation model produces a hull instance mask and a water instance mask, which are resized to image coordinates to determine a top row of the hull and a bottom row of the hull (y_top, y_bot) and defines a lower-half band of the hull (rows y∈[(y_top+y_bot)/2, y_bot]).

13. The system of claim 12, wherein a water region is formed from water masks and/or filled water bounding boxes.

14. The system of claim 13, wherein an overlap area ratio =area(lower-half∩water)/area(lower-half), a depth ratio=(y_bot−y_first_water_in_lower_half)/(y_bot−y_top), where y_first_water_in_lower_half is a smallest row inside the lower-half band of the hull containing any water pixel, and the hull-pitch angle is determined by fitting a line to hull-bottom pixels within a narrow band near y_bot and comparing that line's angle to the image horizon.
